(19) United States
(12) Patent Application Publication
(10) Pub. No.: US 2011/0266976 A1
(43) Pub. Date: Nov. 3, 2011

(54) System and Method of Tuning Current for LEDs

(76) Inventors: Wanfeng Zhang, Palo Alto, CA (US); Pantas Sutardja, Los Gatos, CA (US)

(21) Appl. No.: 13/099,042

(22) Filed: May 2, 2011

Related U.S. Application Data
(60) Provisional application No. 61/329,922, filed on Apr. 30, 2010.
(60) Provisional application No. 61/386,900, filed on Sep. 27, 2010.

(51) Int. Cl. H05B 37/02

(52) U.S. Cl. 315/307

(57) ABSTRACT

An apparatus includes a LED and a regulator circuit. The regulator circuit controls the current provided to the LED according to a calibration signal that is coupled to the current. The regulator circuit adjusts the output of the LED when the calibration signal is adjusted. In this manner, the LED may be calibrated to generate light at a desired brightness level and color level.

### CROSS REFERENCE TO RELATED APPLICATIONS

The present disclosure claims priority to U.S. Provisional App. No. 61/329,922 for “Tuning Linear Regulator Current for LED Lighting to Compensate LED Die to Die Variation” filed Apr. 30, 2010, which is incorporated herein by reference in its entirety for all purposes; and U.S. Provisional App. No. 61/386,900 for “Tuning Linear Regulator Current by OTP for LED Lighting to Compensate LED Die to Die Variation” filed Sep. 27, 2010, which is incorporated herein by reference in its entirety for all purposes.

### BACKGROUND

Particular embodiments generally relate to the fabrication of light emitting diodes (LEDs).

Unless otherwise indicated herein, the approaches described in this section are not prior art to the claims in this application and are not admitted to be prior art by inclusion in this section.

This discussion uses the term “LED” to refer to a LED by itself, and “LED device” to refer to a LED that is connected with other components.

The process of fabricating LED devices (e.g., devices such as integrated circuits that include a LED) is made difficult due to variations in the fabrication process of the LEDs themselves. For example, LEDs produced to have a certain color and brightness will vary around the target due to variations in the fabrication process. The resulting LED devices may also vary in color and brightness, which is often undesirable.

One way to overcome these variations is to use a higher quality LED fabrication process. The variations between LEDs are thereby reduced. However, higher quality processes are more expensive.

Another way to overcome these variations is to perform binning. In binning, LEDs having similar color and brightness levels are sorted into various “bins”. A LED device manufacturer can then select LEDs from a single bin to obtain LEDs with similar color and brightness levels. However, the binning step itself introduces additional cost.

### SUMMARY

According to an embodiment, a method of tuning LED devices is described. The method includes providing a LED and a regulator circuit. The method further includes providing a current to the LED, wherein the regulator circuit is configured to control the current provided to the LED. The method further includes coupling a calibration signal to the current, wherein the calibration signal controls the regulator circuit. The method further includes adjusting the calibration signal to adjust the output of the LED. In this manner, the cost of producing LED devices with uniform brightness or color levels is reduced.

According to an embodiment, the method further includes setting the regulator circuit to control a set current provided to the LED, wherein the set current corresponds to a desired output of the LED.

According to an embodiment, the method further includes providing a programmable memory connected to the regulator circuit. The method further includes burning a set value into the programmable memory when a set current provided to the LED corresponds to a desired output of the LED, wherein the set value corresponds to a value of the calibration signal that results in the desired output of the LED. The method further includes operating the regulator circuit according to the set value burned into the programmable memory. The method further includes operating the LED according to the regulator circuit having been operated according to the set value.

According to an embodiment, the calibration signal is coupled to the current as a high frequency component of the current.

According to an embodiment, an apparatus includes a LED and a regulator circuit. The LED is configured to receive a current. The regulator circuit is connected to the LED and is configured to control the current provided to the LED. The regulator circuit is configured to be controlled by a calibration signal coupled to the current and is configured to adjust the output of the LED when the calibration signal is adjusted.

According to an embodiment, the apparatus further includes a programmable memory connected to the regulator circuit. The programmable memory is configured to store a set value when a set current provided to the LED corresponds to a desired output of the LED, wherein the set value corresponds to a value of the calibration signal that results in the desired output of the LED. The regulator circuit is configured to operate according to the set value stored in the programmable memory, and the LED is configured to operate according to the regulator circuit having been operated according to the set value.

According to an embodiment, the regulator circuit comprises a linear regulator circuit.

According to an embodiment, a system for tuning LED devices includes a calibration unit, a LED, and a regulator circuit. The calibration unit that is configured to generate a current and to couple a calibration signal to the current, wherein the calibration unit is configured to adjust the calibration signal. The LED is configured to receive the current. The regulator circuit is connected to the LED and is configured to control the current provided to the LED. The regulator circuit is configured to be controlled by the calibration signal and to adjust the output of the LED when the calibration signal is adjusted.

According to an embodiment, the calibration unit includes a current source and a signal generator. The current source may be a direct current source or an alternating current source.

The following detailed description and accompanying drawings provide a more detailed understanding of the nature and advantages of the present invention.

### BRIEF DESCRIPTION OF THE DRAWINGS

FIG. 1 is a block diagram of a LED device according to an embodiment.

FIG. 2 is a flowchart of a method that describes the operation of the system of FIG. 1.

FIG. 3 is a block diagram of a system providing alternate details of the calibration unit 102 (see FIG. 1).

FIG. 4 is a block diagram of a system providing alternate details of the calibration unit 102 (see FIG. 1).

FIG. 5 is a block diagram of a system providing alternate details of the calibration unit 102 (see FIG. 1).

### DETAILED DESCRIPTION

Described herein are techniques for fabricating LED devices. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

In this document, various methods, processes and procedures are detailed. Although particular steps may be described in a certain order, such order is mainly for convenience and clarity. A particular step may be repeated more than once, may occur before or after other steps (even if those steps are otherwise described in another order), and may occur in parallel with other steps. A second step is required to follow a first step only when the first step must be completed before the second step is begun. Such a situation will be specifically pointed out when not clear from the context.

In this document, the terms “and”, “or” and “and/or” are used. Such terms are to be read as having the same meaning; that is, inclusively. For example, “A and B” may mean at least the following: “both A and B”, “only A”, “only B”, “at least both A and B”. As another example, “A or B” may mean at least the following: “only A”, “only B”, “both A and B”, “at least both A and B”. When an exclusive-or is intended, such will be specifically noted (e.g., “either A or B”, “at most one of A and B”).

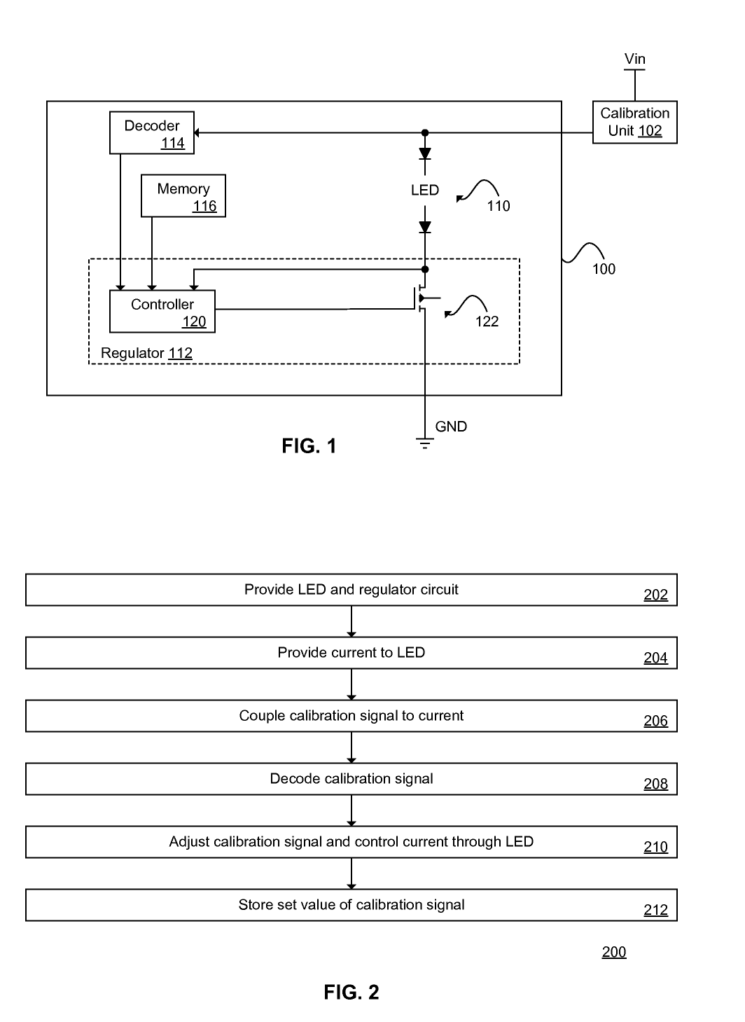

FIG. 1 is a block diagram of a LED device 100 according to an embodiment. The LED device 100 is coupled to a calibration unit 102. The LED device 100 includes a LED 110, a regulator circuit 112, a decoder circuit 114, and a memory 116.

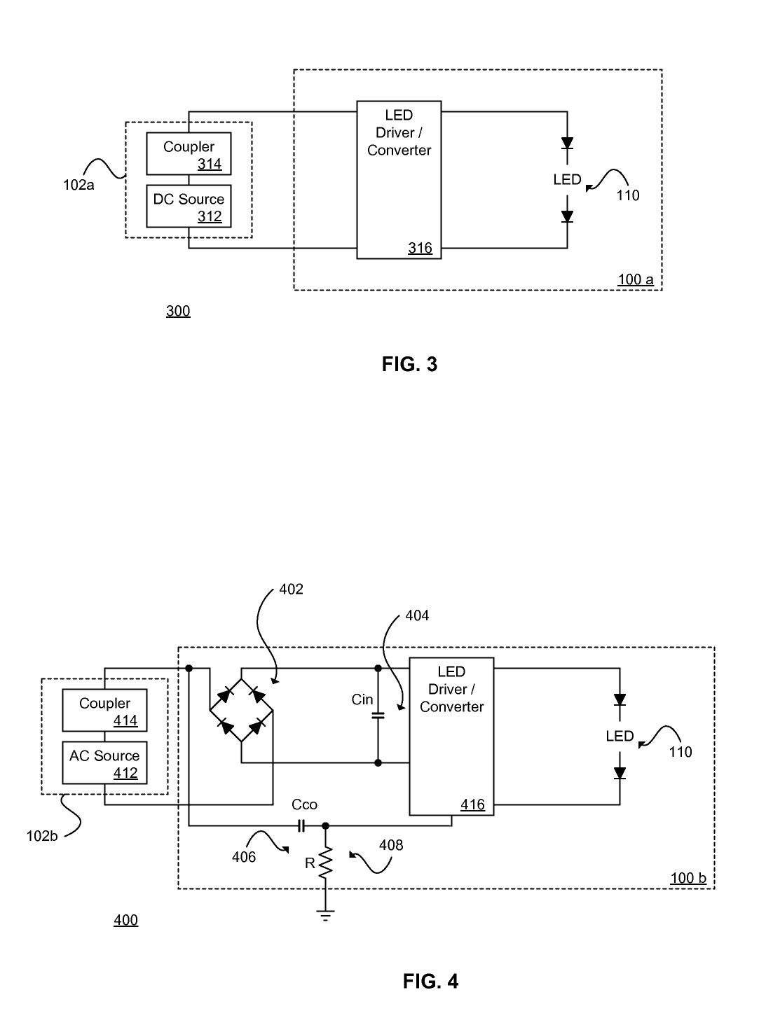

The calibration unit 102 generates a current that is provided to the LED 110 and a calibration signal that is provided to the decoder circuit 114. The calibration unit 102 may provide a direct current or an alternating current (see FIGS. 3-5). The calibration unit 102 provides a voltage that is 24 volts according to an embodiment. The calibration signal is a high frequency signal, for example between around 1 MHz to 10 MHz.

The decoder circuit 114 decodes the calibration signal from the current and provides the calibration signal to the regulator circuit 112. The decoder circuit 114 may also control the storage of information in the memory 116, for example by decoding “store” or “erase” signals from the calibration signal and controlling the memory 116 as discussed below.

The memory 116 stores a set value that corresponds to the calibration signal for use by the regulator circuit 112. According to an embodiment, the memory 116 is a one time programmable (OTP) memory circuit into which the set value is stored once the LED 110 has been tuned to output the desired brightness level and color level. The process of storing the set value may be referred to as “setting” or “burning” the memory 116. According to an embodiment, the memory 116 is eraseably programmable. For example, the calibration signal may include an “erase” signal to erase the presently stored value, and a “store” signal to store a new value that corresponds to the calibration signal.

The regulator circuit 112 receives the calibration signal (as decoded by the decoder circuit 114) and controls the current from the calibration unit 102 through the LED 110. The regulator circuit 112 includes a controller circuit 120 and a transistor 122. The controller circuit 120 uses the calibration signal to set the voltage at the gate of the transistor 122. Once the LED device 100 has been tuned, or there is otherwise no calibration signal provided, the controller circuit 120 uses the set value stored in the memory 116 (instead of the calibration signal) to control the transistor 122. According to an embodiment, the regulator circuit 112 is a linear regulator circuit. According to an embodiment, the transistor 122 is a metal oxide semiconductor field effect transistor (MOSFET).

According to an alternate embodiment, the regulator circuit 112 is between the calibration unit 102 and the LED 110.

According to an alternate embodiment, the LED 110 is connected outside the LED device 100. The LED 110 may be connected between the calibration unit 102 and the regulator circuit 112 (as shown in FIG. 1). Alternatively the regulator circuit 112 may be connected between the calibration unit 102 and the LED 110 (as discussed in the previous paragraph).

FIG. 2 is a flowchart of a method 200 that describes the operation of the system of FIG. 1.

At 202, the LED 110 and the regulator circuit 112 are provided. These may be provided together as a single device (e.g., the LED device 100 as shown in FIG. 1) or they may be provided separately (e.g., according to the alternate embodiment where the LED 110 is connected outside the LED device 100).

At 204, the calibration unit 102 provides a current to the LED 110. The regulator circuit 112 is configured to control the current provided to the LED 110.

At 206, the calibration unit 102 couples a calibration signal to the current. The calibration signal controls the regulator circuit 112.

At 208, the decoder circuit 114 decodes the calibration signal from the current and provides the calibration signal (having been decoded) to the regulator circuit 112. The regulator circuit 112 uses the calibration signal to control the current through the LED 110.

At 210, the calibration unit 102 adjusts the calibration signal to adjust the output of the LED 110. This adjustment may be part of the general process of tuning the LED 110 so that the LED device 100 generates light at a desired brightness level and color level. For example, the calibration signal may control the regulator circuit 112 to increase the current through the LED 100, thereby increasing the brightness level or color level. Alternatively, the calibration signal may control the regulator circuit 112 to decrease the current through the LED 110, thereby decreasing the brightness level or color level.

At 212, when the LED 110 is generating a desired output, the calibration unit sends a “burn” signal in the calibration signal, and the decoder circuit 114 instructs the memory 116 to store the appropriate value of the calibration signal that results in that output from the LED 110. The regulator circuit 112 is then “set” to use the stored value in the memory 116 to control the appropriate current level through the LED 110.

According to an embodiment, the LED device 100 is configured once; thus an OTP memory may be used as the memory 116. According to an alternate embodiment, the LED device 100 may be adjusted (using the configuration signal) more than once. For example, the LED device 100 may be configured multiple times, or may be adjusted (using the configuration signal) during the normal operation of the LED device 100; thus an eraseably programmable memory may be used as the memory 116, or the memory 116 may be omitted.

FIG. 3 is a block diagram of a system 300 providing alternate details of the calibration unit 102 (see FIG. 1). The system 300 includes a direct current calibration unit 102a and a LED device 100a. The direct current calibration unit 102a is similar to the calibration unit 102 (see FIG. 1), except that a direct current is explicitly provided to the LED device 100a. The direct current calibration unit 102a includes a direct current source 312 and a coupler 314. The direct current source 312 provides a direct current. The coupler 314 couples the calibration signal onto the direct current.

The LED device 100a includes a LED 110 (cf. FIG. 1) and a LED driver/converter 316. The LED driver/converter 316 includes the regulator circuit 112, the decoder circuit 114, and the memory 116 (see FIG. 1). The LED device 100a is otherwise similar to the LED device 100 (see FIG. 1).

FIG. 4 is a block diagram of a system 400 providing alternate details of the calibration unit 102 (see FIG. 1). The system 400 includes an alternating current calibration unit 102b, a LED device 100b, a full bridge rectifier circuit 402, an input capacitor 404, a coupling capacitor 406, and a resistor 408. The alternating current calibration unit 102b is similar to the calibration unit 102 (see FIG. 1), except that an alternating current is explicitly provided to the LED device 100b. The alternating current calibration unit 102b includes an alternating current source 412 and a coupler 414. The alternating current source 412 provides an alternating current. The coupler 414 couples the calibration signal onto the alternating current.

The LED device 100b is similar to the LED device 100 (see FIG. 1), with the addition of the full bridge rectifier circuit 402 and the input capacitor 404. The full bridge rectifier circuit 402 rectifies the alternating current into a direct current, and the input capacitor 404 filters any voltage ripple. The LED device 100b includes a LED 110 (cf. FIG. 1) and a LED driver/converter 416. The LED driver/converter 416 includes the regulator circuit 112, the decoder circuit 114, and the memory 116 (see FIG. 1).

The coupling capacitor 406 couples the calibration signal on the resistor 408; the calibration signal is then provided to the LED device 100b in a manner similar to that described above (see the LED device 100 of FIG. 1).

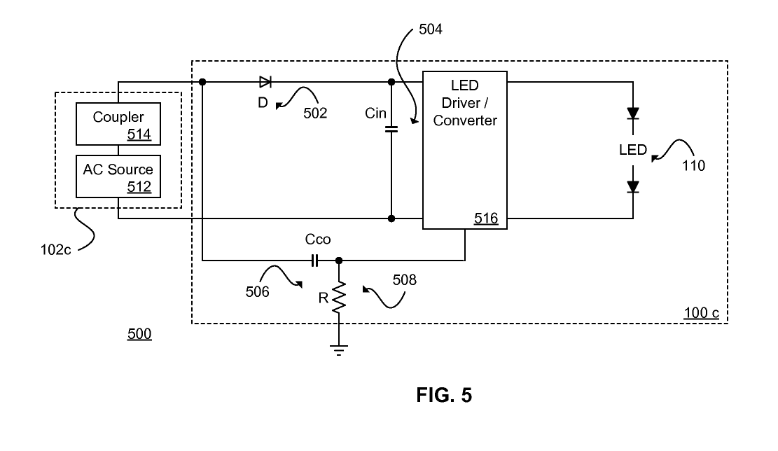

FIG. 5 is a block diagram of a system 500 providing alternate details of the calibration unit 102 (see FIG. 1). The system 500 includes an alternating current calibration unit 102c, a LED device 100c, a half bridge rectifier circuit 502, an input capacitor 504, a coupling capacitor 506, a resistor 508, and the LED driver/converter 516. The alternating current calibration unit 102c is similar to the calibration unit 102b (see FIG. 4) and includes an alternating current source 512 and a coupler 514. The LED driver/converter 516 is similar to the LED driver/converter 416 (see FIG. 4), as are the input capacitor 504 (cf. the input capacitor 404), the coupling capacitor 506 (cf. 406), and the resistor 508 (cf. 408). The LED device 100c is similar to the LED device 100b (see FIG. 4), with the half bridge rectifier circuit 502 replacing the full bridge rectifier circuit 402. The half bridge rectifier circuit 502 rectifies the alternating current into a direct current in a manner similar to that described above (see the full bridge rectifier circuit 402 of FIG. 4).

An embodiment may have various advantages as compared to existing devices. First, as compared to using a higher quality LED fabrication process to reduce variation among LEDs, a less expensive process may be used. The less expensive LEDs may then be calibrated, using the calibration signal when the LED devices are manufactured, to generate light at the desired brightness level or color level. Second, as compared to binning to reduce variation among LEDs, the expense of a binning step may be avoided. Instead, the LEDs may be calibrated, using the calibration signal when the LED devices are manufactured, to generate light at similar brightness levels or color levels. Third, since the calibration signal is coupled with the current, a separate calibration wire or other connection is not required for the LED device. As a consequence, the LED device may be made smaller or less expensively by omitting this separate calibration wire or other connection.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method of tuning light emitting diode (LED) devices, comprising:
providing a LED and a regulator circuit;
providing a current to the LED, wherein the regulator circuit is configured to control the current provided to the LED;
coupling a calibration signal to the current, wherein the calibration signal controls the regulator circuit; and
adjusting the calibration signal to adjust the output of the LED.

2. The method of claim 1, further comprising:
setting the regulator circuit to control a set current provided to the LED, wherein the set current corresponds to a desired output of the LED.

3. The method of claim 1, wherein coupling the calibration signal comprises coupling the calibration signal to the current as a high frequency component of the current.

4. The method of claim 1, further comprising:
providing a programmable memory connected to the regulator circuit;
burning a set value into the programmable memory when a set current provided to the LED corresponds to a desired output of the LED, wherein the set value corresponds to a value of the calibration signal that results in the desired output of the LED;
operating the regulator circuit according to the set value burned into the programmable memory; and
operating the LED according to the regulator circuit having been operated according to the set value.

5. The method of claim 1, further comprising:
decoding the calibration signal from the current.

6. An apparatus, comprising:
a light emitting diode (LED) that is configured to receive a current; and
a regulator circuit connected to the LED, wherein the regulator circuit is configured to control the current provided to the LED, wherein the regulator circuit is configured to be controlled by a calibration signal coupled to the current, and wherein the regulator circuit is configured to adjust the output of the LED when the calibration signal is adjusted.

7. The apparatus of claim 6, wherein the calibration signal is coupled to the current as a high frequency component of the current.

8. The apparatus of claim 6, further comprising:
a programmable memory connected to the regulator circuit, wherein the programmable memory is configured to store a set value when a set current provided to the LED corresponds to a desired output of the LED, wherein the set value corresponds to a value of the calibration signal that results in the desired output of the LED,
wherein the regulator circuit is configured to operate according to the set value stored in the programmable memory, and
wherein the LED is configured to operate according to the regulator circuit having been operated according to the set value.

9. The apparatus of claim 6, further comprising:
a decoder circuit connected to the regulator circuit, that is configured to decode the calibration signal from the current and to provide the calibration signal having been decoded to the regulator circuit.

10. The apparatus of claim 6, wherein the LED and the regulator circuit are implemented together on a single device.

11. The apparatus of claim 6, wherein the LED and the regulator circuit are implemented as separate devices.

12. The apparatus of claim 6, wherein the regulator circuit comprises a linear regulator circuit.

13. The apparatus of claim 6, wherein the regulator circuit comprises:
a transistor connected to the LED, wherein the transistor has a gate; and
a controller circuit that is connected to the gate of the transistor.

14. The apparatus of claim 6, wherein the current comprises an alternating current, further comprising:
a full bridge rectifier that is configured to rectify the alternating current into the current for the LED to receive;
a resistor; and
a capacitor, connected to the resistor, that couples the calibration signal on the resistor for the regulator circuit to receive.

15. The apparatus of claim 6, wherein the current comprises an alternating current, further comprising:
a half bridge rectifier that is configured to rectify the alternating current into the current for the LED to receive;
a resistor; and
a capacitor, connected to the resistor, that couples the calibration signal on the resistor for the regulator circuit to receive.

16. A system for tuning light emitting diode (LED) devices, comprising:
a calibration unit that is configured to generate a current and to couple a calibration signal to the current, wherein the calibration unit is configured to adjust the calibration signal;
a light emitting diode (LED) that is configured to receive the current; and
a regulator circuit connected to the LED, wherein the regulator circuit is configured to control the current provided to the LED, wherein the regulator circuit is configured to be controlled by the calibration signal, and wherein the regulator circuit is configured to adjust the output of the LED when the calibration signal is adjusted.

17. The system of claim 16, wherein the calibration unit is configured to couple the calibration signal to the current as a high frequency component of the current.

18. The system of claim 16, further comprising:
a programmable memory connected to the regulator circuit, wherein the programmable memory is configured to store a set value when a set current provided to the LED corresponds to a desired output of the LED, wherein the set value corresponds to a value of the calibration signal that results in the desired output of the LED,
wherein the regulator circuit is configured to operate according to the set value stored in the programmable memory, and
wherein the LED is configured to operate according to the regulator circuit having been operated according to the set value.

19. The system of claim 8, wherein the calibration unit comprises:
a direct current source that is configured to generate the current, wherein the current is a direct current; and
a signal generator that is configured to generate the calibration signal and to couple the calibration signal to the direct current.

20. The system of claim 8, wherein the calibration unit comprises:
an alternating current source that is configured to generate the current, wherein the current is an alternating current; and
a signal generator that is configured to generate the calibration signal and to couple the calibration signal to the alternating current.
